(19) United States
(12) Patent Application Publication
(10) Pub. No.: US 2002/0171629 A1
(43) Pub. Date: Nov. 21, 2002

(54) Low power measurement circuit for position sensor

(76) Inventors: Steven W. Archibald, Ogden, UT (US); Tracy W. Lay, Ogden, UT (US)

Correspondence Address: CHRISTIE, PARKER & HALE, LLP, 350 WEST COLORADO BOULEVARD, SUITE 500, PASADENA, CA, 91105, US

(21) Appl. No.: 09/862,883

(22) Filed: May 21, 2001

(51) Int. Cl. G09G 5/08

(52) U.S. Cl. 345/157

(57) ABSTRACT

A low power measurement circuit for a position sensor incorporating strain gauges. The position sensor includes a bridge resistive network coupled to a multiplexer. The multiplexer routes current through different portions of the position sensor creating different resistive networks sensitive to forces applied to the position sensor. Current flowing through the resistive networks generate output signals proportional to the forces applied to the position sensor. A sample and hold circuit allows the position sensor to be de-energized while an analog to digital converter digitizes the output signals. A programmable controller and a digital to analog converter are included to create a flexible amplifier stage. The circuit further includes a controller for controlling the operation of the multiplexer, programmable amplifier, digital to analog converter, and analog to digital converter.

### BACKGROUND OF THE INVENTION

This invention relates generally to strain gauges and specifically to a differential strain gauge used as an input device for computer systems or other handheld devices.

Strain gauges are used to measure the strain or distortion in a member, and strain gauges are used in a variety of applications. Strain gauges often include a sensing element and a measuring element. The sensing element exhibits a change in a physical property in response to an applied force. The measuring element provides an indication of the change in the physical property of the sensing element.

In some applications the sensing element may be strain sensitive resistors. Strain sensitive resistors are generally composed of a piezo-resistive material that exhibits changes in resistivity in response to an applied force, particularly compressive or tensile forces.

An input device sensitive in three axes and sensitive to the magnitude of the force applied by a user may be constructed using strain sensitive resistors. In such an input device, strain sensitive resistors are configured so that they change resistance in response to forces applied in various directions to the input device by a user.

An example of such an input device is a post-type computer cursor control. With a post-type cursor control a user manipulates a cursor by deflecting a post extending from a keyboard area. Since a cursor moves across a two-dimensional screen, the cursor control should detect user input along two perpendicular axes. Furthermore, the cursor control should also be sensitive to the magnitude of the force applied by the user, resulting in displacement of the post, in response to a user's input. This sensitivity to the magnitude of the applied force allows the cursor control to be used to control both the direction of movement of the cursor and the speed with which the cursor moves. Additionally, the cursor control should also be sensitive to force applied in a third axis so that the input device can be used to detect when a user intends to select an item from the screen at a cursor's position. Finally, the cursor control should be simple to manufacture, robust, and insensitive to noise and fluctuations in temperature.

Input, devices using strain gauges have several characteristics that limit their use in certain applications. The need to measure multiple axes simultaneously may require that multiple independent resistor circuits be employed. These resistor circuits may need to be energized simultaneously and continuously leading to a large current drain. Furthermore, the multiple independent circuits may have different sensitivities and response characteristics creating a need for separate amplification and digitizing circuits increasing the complexity of the measurement system.

Accordingly, a need exists for a strain gauge-based input device and related measurement circuit with reduced power demands.

### SUMMARY OF THE INVENTION

The present invention provides, in one embodiment, a device in a cursor control system. The device comprises a columnar element extending from a flexible substrate. A first pair of resistive elements are mounted to the substrate. The resistivity of the first pair of resistive elements changes with flexing of the substrate. A first signal provides an indication of the series resistivity of first resistive element of the first pair of resistive elements. A second signal provides an indication of the resistivity of a second resistive element of the first pair of resistive elements. A signal processing circuit receiving the first and second signal provides an output indicative of the magnitude of the force applied to the columnar element.

In one embodiment, the first pair of resistive elements is mounted to the substrate substantially on opposite sides of a location on the substrate from which the columnar element extends.

In another embodiment, a multiplexer is used in conjunction with an analog front end to take measurements from the resistive elements.

### BRIEF DESCRIPTION OF THE DRAWINGS

These and other features, aspects, and advantages of the present invention will become better understood with regard to the following description, appended claims, and accompanying drawings where:

FIG. 1 is a diagram depicting the use of a pointing device embedded in a keyboard to control a cursor;

FIG. 2 is an isometric view of a pointing device sensor according to the present invention;

FIG. 3 is a bottom view of a pointing device sensor according to the present invention;

FIG. 4 is a block diagram of an exemplary embodiment of an input device sensor and signal processing circuit comprising a resistive sensor measurement system according to the present invention;

FIG. 5 is an electrical schematic of an embodiment of a pointing device sensor used to measure force along an X axis according to the present invention;

FIG. 6 is an electrical schematic of an embodiment of a pointing device sensor used to measure force along an Y axis according to the present invention;

FIG. 7 is an electrical schematic of an embodiment of a pointing device sensor used to measure force along a Z axis according to the present invention;

FIG. 8 is a block diagram of an embodiment of a signal processing circuit suitable for use as a driver for an embodiment of a pointing device sensor according to the present invention; and

FIG. 9 is an electrical schematic of an embodiment of a sample and hold circuit according to the present invention.

### DETAILED DESCRIPTION

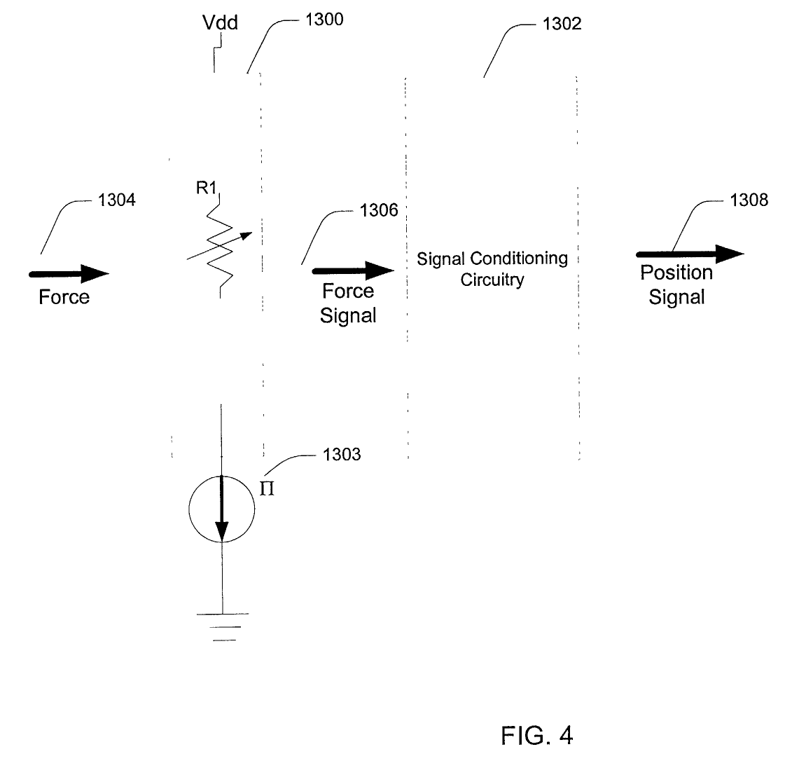

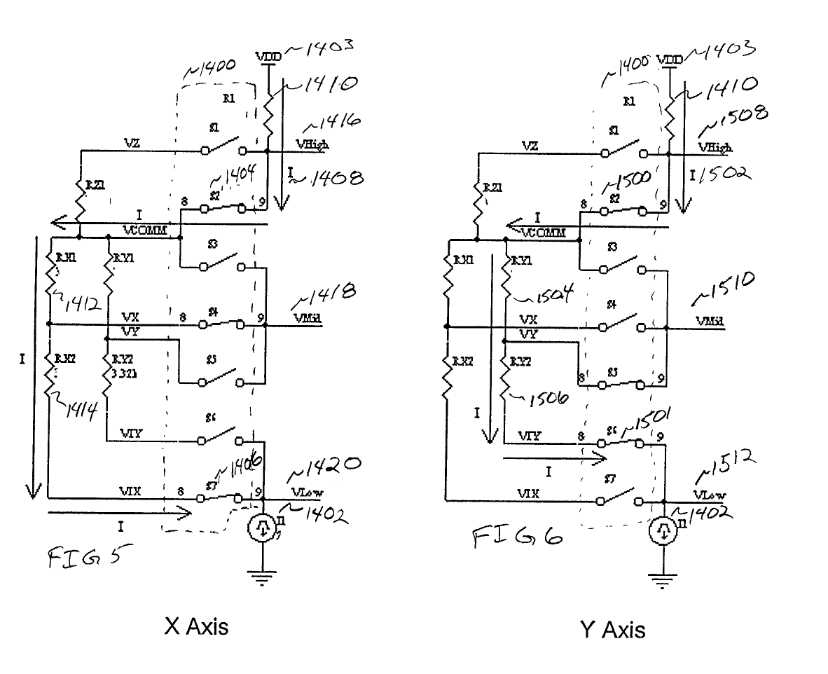

FIG. 4 is a block diagram of an exemplary embodiment of an input device sensor and signal processing circuit comprising a resistive sensor measurement system according to the present invention. A resistive sensor network 1300 is operably coupled to a signal processing circuit 1302 and a constant current source 1303. The resistive sensor network contains a variable resistor R1. Application of a force 1304 to the resistive network causes the resistance of the variable resistor to change. The current flows through the variable resistor, generating a force signal 1306 indicative of the magnitude of the applied force. Changes in the applied force cause proportional changes in the variable resistor's resistance that cause proportional changes in the force signal. The force signal is transmitted to the signal processing circuitry. The signal processing circuitry transforms the force signal into a position signal 1308 for use by other devices such as a cursor control device.

An example of a system including a resistive sensor measurement system in accordance with the present invention is shown in FIG. 1. FIG. 1 is a diagram depicting the use of a pointing device embedded in a keyboard to control a cursor. Processor 1040 is operably coupled to screen display 1000. The processor sends control signals to the screen display to generate a display 1030 containing text element 1020. The processor is also operably coupled to keyboard 1050. A user uses the keyboard to send keystroke signals from the keyboard to the processor. The processor interprets the keystroke signals and processes the keystroke signals to create the display.

The display also contains pointing cursor 1010. The pointing cursor is movable in an X 1070 direction and a Y 1080 direction across the display in response to control signals generated by the processor. The processor generates these commands in response to cursor command signals sent from the keyboard. The cursor command signals are sometimes generated in response to depressions of keys, but are often generated in response to deflection of a pointing device 1060 on the keyboard.

The pointing device may be deflected horizontally and vertically. Pressing the pointing device horizontally from left to right sends cursor command signals to the processor and the processor interprets these cursor command signals to move the cursor in a positive X direction. Pressing the pointing device horizontally from right to left sends cursor command signals to the processor and the processor interprets these cursor command signals to move the cursor in a negative X direction. Pressing the pointing device horizontally from the front of the keyboard to back of the keyboard sends cursor command signals to the processor and the processor interprets these cursor command signals to move the cursor in a positive Y direction. Pressing the pointing device horizontally from the back of the keyboard to front of the keyboard sends cursor command signals to the processor and the processor interprets these cursor command signals to move the cursor in a negative Y direction. Pressing the pointing device down into the keyboard sends cursor command signals to the processor and the processor interprets these cursor command signals as a selection event.

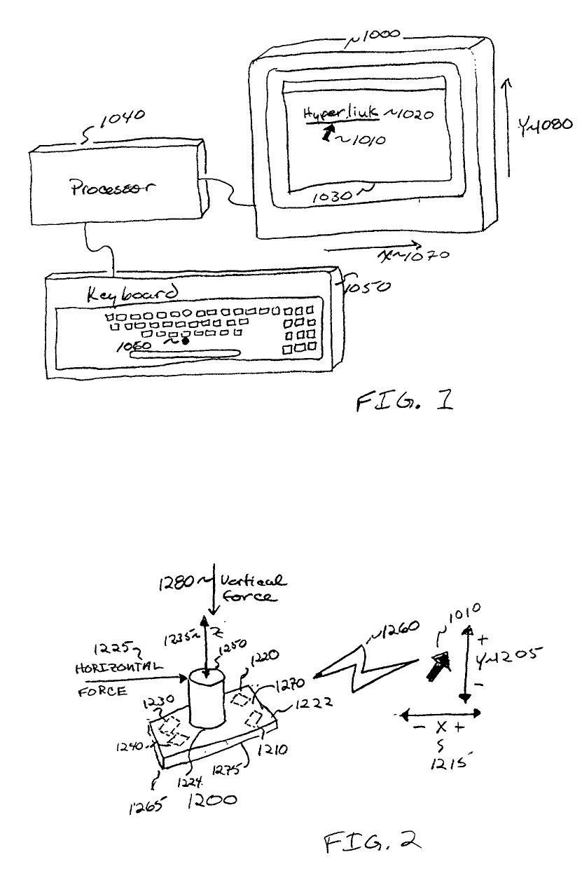

FIG. 2 is an isometric view of a pointing device sensor according to the present invention. Pointing device sensor 1200 is used to sense horizontal and vertical forces applied to the pointing device 1060 (FIG. 1). The body of the pointing device sensor comprises a substrate 1265 and a columnar post 1250. The substrate has a center portion 1224 and peripheral portion 1222, top surface 1270, and bottom surface 1275 opposite the top surface. The post comprises a bottom portion and a top portion. The bottom portion of the post is fixedly mounted to the top surface of the substrate substantially within the center portion of the substrate. A longitudinal axis of the post is perpendicular to the top surface of the substrate such that the longitudinal axis of the post extends along Z axis 1235 projecting away from the top surface of the substrate.

Four resistive elements, 1210, 1220, 1230, and 1240 are fixedly mounted to the bottom surface of the substrate substantially in the center of the substrate under the region of the post. In one embodiment the resistive elements are mounted substantially adjacent the post. The resistive elements are thick film strain gauge resistors that change resistance in response to being flexed. A first pair of thick film strain gauge resistors is positioned on either side of the post defining a first axis with the post falling on the axis. A second pair thick film strain gauge resistors is positioned on either side of the post and in such a way that a second axis is defined, orthogonal to the first axis with the post falling on the second axis.

In operation, the peripheral portion of the substrate is fixedly attached to a stiff support to prevent the substrate from rocking as force is applied to the post but allowing the substrate to flex in response to the applied force. Applying horizontal force 1225 to the top portion of the post causes the substrate to flex, flexing the fixedly mounted thick film strain gauge resistors. This flexing of the thick film strain gauge resistors creates a strain in the thick film strain gauge resistors causing changes in the resistance of the thick film strain gauge resistors. These changes in resistance in the thick film strain gauge resistors caused by the horizontal force applied to the post are converted into electrical signals 1260 that are interpreted by a processor to move cursor 1010 in X 1215 and Y 1205 directions within a display as previously described.

In a like manner, applying vertical force 1280 to the top portion of the post causes the substrate to flex causing changes in the resistance of the thick film strain gauge resistors. These changes in resistance in the thick film strain gauge resistors caused by the vertical force applied to the post are converted into electrical signals that are interpreted by a processor to select text or an item at a current cursor location in a display as previously described.

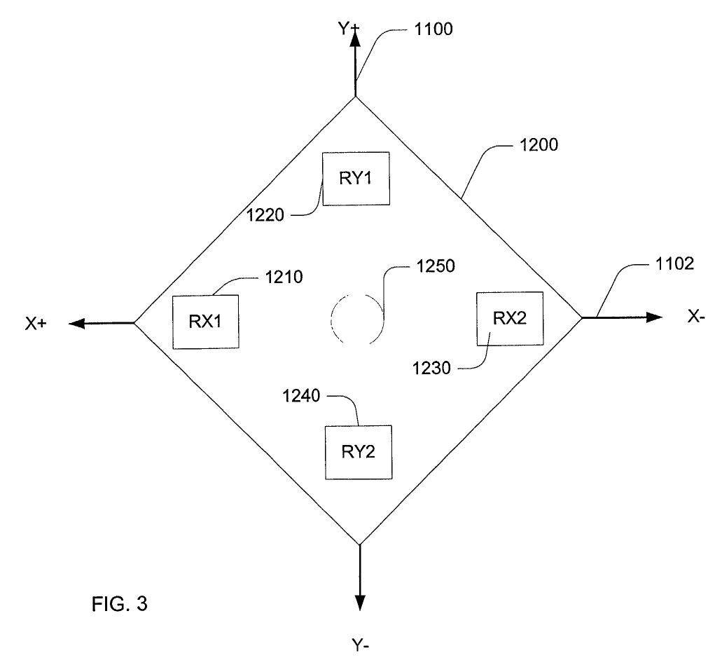

FIG. 3 is a bottom view of a pointing device sensor according to the present invention. The view is of bottom surface 1275 of substrate 1265 of pointing device sensor 1200 (all of FIG. 2). The view is oriented such that a first pair of thick film strain gauge resistors, RY1 1220 and RY2 1240, fixed to the bottom surface of the substrate define Y axis 1100 as previously described. A second pair of thick film strain gauge resistors, RX1 1210 and RX2 1230, fixed to the bottom surface of the substrate defines X axis 1102 as previously described. The thick film strain gauge resistors RY1 and RY2 are separated by post 1250 mounted on front surface 1270 (FIG. 2) of the substrate.

A horizontal force applied to the top portion of the post and parallel with the Y axis causes the substrate to flex. This flexing creates an equal and opposite resistance change in thick film strain gauge resistors RY1 and RY2. If the horizontal force parallel to the Y axis is in the positive direction as previously described, the resistance of thick film strain gauge resistor RY1 increases and the resistance of thick film strain gauge resistor RY2 decreases. If the horizontal force parallel to the Y axis is in the negative Y direction as previously described, the resistance of thick film strain gauge resistor RY1 decreases and the resistance of thick film strain gauge resistor RY2 increases.

Thick film strain gauge resistors RX1 and RX2 are fixedly mounted to the bottom surface of the substrate along the X axis. The thick film strain gauge resistors RX1 and RX2 are separated by the post mounted on front surface 1270 (FIG. 2) of the substrate. A horizontal force applied to the top portion of the post and parallel with the X axis causes the substrate to flex. This strain creates an equal and opposite resistance change in thick film strain gauge resistors RX1 and RX2. If the horizontal force parallel to the X axis is in the positive direction, the resistance of thick film strain gauge resistor RX1 increases and the resistance of thick film strain gauge resistor RX2 decreases. If the horizontal force parallel to the X axis is in the negative X direction, the resistance of thick film strain gauge resistor RX1 decreases and the resistance of thick film strain gauge resistor RX2 increases.

Thick film strain gauge resistors RX1, RX2, RY1, and RX2 are fixedly mounted to the bottom surface of the substrate in such a way that application of vertical force 1280 (FIG. 2) to the top portion of the post causes the resistance of the thick film strain gauge resistors to increase.

The resistance in each of thick film strain gauge resistors is given by:

Res=R+R_{T}+rₕ+r_{z}

Where:

Res=Resistance of the strain gauge

R=Base resistance of the strain gauge

R_{T}=Tolerance resistance of the strain gauge

rₕ=Change in resistance from a horizontal force

r_{z}=Change in resistance from a vertical force

The resistance for each of the thick film strain gauge resistors of FIG. 3 is then:

RX1=R+R_{TX1}+rₓ+r_{z}

RX2=R+R_{TX2}−rₓ+r_{z}

RY1=R+R_{TY1}+r_{y}+r_{z}

RY2=R+R_{TY2}−r_{y}+r_{z}

FIG. 5 is an electrical schematic of an embodiment of a pointing device sensor used to measure force along an X axis according to the present invention. The pointing device sensor is operably coupled via a multiplexer 1400 to a constant current source 1402 and a voltage source VDD. In operation, a constant current is applied to two resistive sensors connected in series for each axis measurement.

To make an X axis measurement, switch S2 1404 and switch S7 1406 are closed allowing current 11408 to flow through a biasing resistor R1 1410, a positive X axis resistive sensor RX1 1412, and a negative X axis resistive sensor RX2 1414 to ground, creating a X axis resistive sensor network.

Three signals generated by the current flowing through the X axis resistive sensor network are used to determine the resistance of the X axis resistive sensors. An excitation signal, VHigh 1416, is generated at a connection point between the biasing resistor R1 and the two X axis resistive sensors. A midpoint signal, VMid 1418, is generated at a connection point between the positive and negative X axis resistive sensors. An endpoint signal, VLow 1420, is generated at a connection point above the constant current source and after the X axis resistive sensor network.

The voltage across the positive X axis resistive sensor is then VHigh−VMid which is equal to I times RX1. The voltage across the negative X axis resistive sensor is then VMid−VLow which is equal to I times RX2. In each case, if the current is known, the resistance of the resistive sensors can be calculated from the three measured voltages, VHigh, VMid, and VLow. A value proportional to a force applied along the X axis to the pointing device sensor is generated by taking the difference between the resistance values of the X axis resistive sensors.

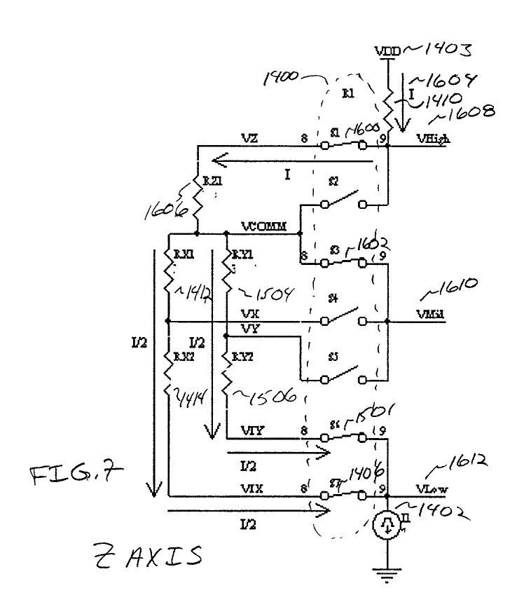

FIG. 6 is an electrical schematic of an embodiment of a pointing device sensor used to measure force along an Y axis according to the present invention. The pointing device sensor is operably coupled via a multiplexer 1400 to a constant current source 1402 and a voltage source VDD 1403 as previously described.

To make an Y axis measurement, switch S2 1500 and switch S6 1501 are closed allowing current 11508 to flow through the biasing resistor R1 1410, a positive Y axis resistive sensor RY1 1504, and a negative Y axis resistive sensor RY2 1506 to ground creating an Y axis resistive sensor network.

Three signals generated by the current flowing through the Y axis resistive sensor network are used to determine the resistance of the Y axis resistive sensors. An excitation signal, VHigh 1508, is generated at a connection point between the biasing resistor R1 and the two Y axis resistive sensors. A midpoint signal, VMid 1510, is generated at a connection point between the positive and negative Y axis resistive sensors. An endpoint signal, VLow 1512, is generated at a connection point above the constant current source and below the Y axis resistive sensor network.

The voltage across the positive Y axis resistive sensor is then VHigh−VMid which is equal to I times RY1. The voltage across the negative Y axis resistive sensor is then VMid−VLow which is equal to I times RY2. In each case, if the current is known, then the resistance of the two resistive sensors can be calculated from the three measured voltages, VHigh, VMid, and VLow. A value proportional to a force applied along the Y axis to the pointing device sensor is generated by taking the difference between the resistance values of the Y axis resistive sensors.

FIG. 7 is an electrical schematic of an embodiment of a pointing device sensor used to measure force along a Z axis according to the present invention. The pointing device sensor is operably coupled via a multiplexer 1400 to a constant current source 1402 supplied by a voltage source VDD 1403 as previously described.

To make a Z axis measurement, switch S1 1600, switch S3 1602, switch S6 1501, and switch S7 1406 are closed allowing current 11604 to flow through the biasing resistor R1 1410, a Z axis reference resistor RZ1 1606, the positive Y axis resistive sensor RY1 1504, the negative Y axis resistive sensor RY2 1506, the positive X axis resistive sensor RX1 1412, and the negative X axis resistive sensor RX2 1414 to ground. This creates a Z axis resistive sensor network with the biasing resistor and the Z axis reference resistor in series with a parallel circuit created by the X and Y axis resistive sensors in a bridge configuration.

Each leg of the parallel circuit comprises two oppositely biased axis resistive sensors in series. This arrangement cancels out the change in resistance values created in the axis resistive sensors generated by forces applied along the X and Y axes to the pointing device sensor. Combination of the X and Y axis resistive sensors in this way creates a single Z axis resistive element sensitive to forces applied along the Z axis to the pointing device sensor. The combination of the biasing resistor, Z axis reference resistor, and the Z axis resistive element creates a Z axis resistive sensor network.

Three signals generated by the current flowing through the Z axis resistive sensor network are used to determine the resistance of the Z axis resistive elements. An excitation signal, VHigh 1608, is generated at a connection point between the biasing resistor R1 and the Z axis reference resistor. A midpoint signal, VMid 1610, is generated at a connection point between the Z axis reference resistor and the Z axis resistive element. An endpoint signal, VLow 1612, is generated at a connection point above the constant current source and below the Z axis resistive sensor network.

The voltage across the Z axis reference resistor is then VHigh−VMid which is equal to I times RZ1. The voltage across the Z axis resistive element is then VMid−VLow which is equal to I times resistance of the Z axis resistive element. If the current is known, the resistance of the Z axis resistive element can be calculated from VMid and VLow. The resistance value of the Z axis resistive element is then proportional to the force applied to the pointing device sensor along the Z axis.

Configuration of a pointing device sensor in the above described manner allows the pointing device sensor to be selectively energized to take X, Y, and Z measurements. This reduces the amount of power required by the pointing device sensor because the entire pointing device sensor need not be energized at one time. Additionally, the pointing device sensor can be energized only during the time a measurement needs to be taken and completely de-energized when no measurements need to be taken.

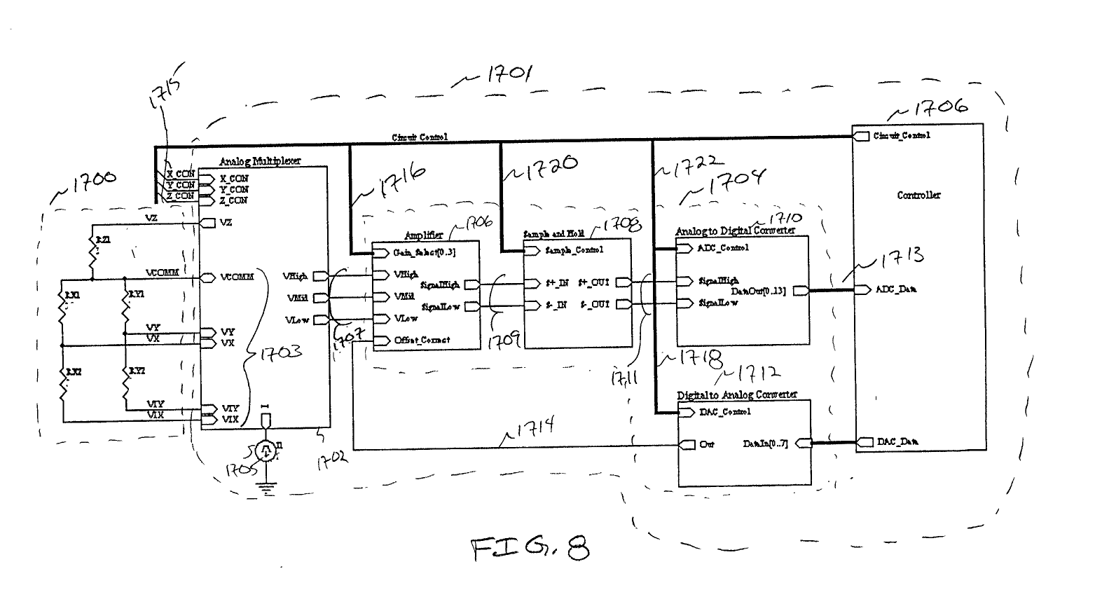

FIG. 8 is a block diagram of an embodiment of a signal processing circuit suitable for use as a driver for an embodiment of a pointing device sensor according to the present invention. A previously described pointing device sensor comprising a resistive sensor network 1700 is operably coupled to the signal processing circuit 1701. The signal processing circuit provides an excitation current signal 1705 to the resistive sensor network and the resistive sensor network transmits to the signal processing circuit the previously described force signals 1703 proportional to the forces applied to the pointing device sensor. The signal processing circuit generates position signals proportional to the applied forces using the received force signals.

The signal processing circuit comprises a signal processing stage 1704 and an analog signal multiplexer 1702 operably coupled to a controller 1706. The controller issues control signals to the multiplexer in order to energize the different circuits available in the resistive sensor network for measuring forces applied to the pointing device sensor along the X, Y, and Z axes. Force signals generated by the pointing device sensor are transmitted from the pointing device sensor through the multiplexer into the signal processing stage as the previously described VHigh, VMid, and VLow signals 1707. The signal processing stage generates position signals using the force signals under the control of the controller.

In one embodiment of a controller according to the present invention, control logic for the operation of the signal processing circuit is hard wired within the controller.

In one embodiment of a controller according to the present invention, the controller comprises a processor a Read Only Memory (ROM), and a Random Access Memory (RAM). The ROM includes programming instructions encoding the control logic. In operation, the processor executes the programming instructions and stores intermediate processing results in the RAM.

The signal processing stage comprises a amplifier 1706 operably coupled to an Analog to Digital Converter (ADC) 1710 via a sample and hold circuit 1708. The amplifier receives the force signals 1701 from the multiplexer and amplifies the force signals under the control of the controller.

In one embodiment of a signal processing circuit according to the present invention, the amplifier is a programmable gain amplifier. The controller adjusts the gain of the programmable gain amplifier according to the measured axis. For example, the X and Y axis resistive sensors are used in parallel with a Z axis reference resistor to create a Z axis resistive sensor network. This Z axis resistive sensor network has a signal range that is much lower than when either a X or Y axis resistive sensor network is used. Therefore, the controller increases the gain of the programmable gain amplifier whenever a Z axis measurement is taken.

In one embodiment of a signal processing stage according to the present invention, Z axis measurements are not taken and an amplifier with a single gain is used.

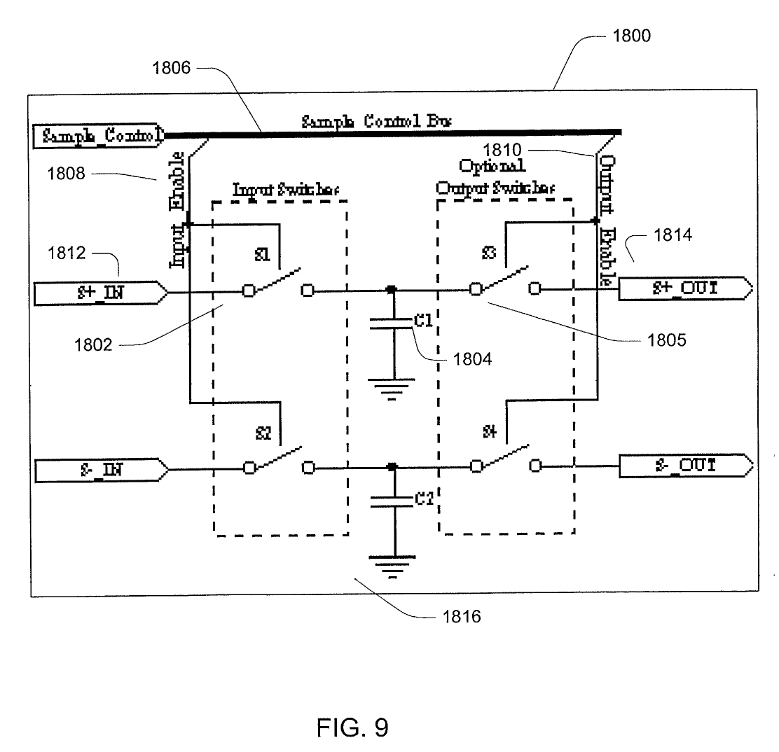

The amplifier transmits amplified force signals 1709 to the programmable sample and hold circuit. The controller drives the sample and hold circuit to capture the amplified force signals during a measurement cycle. The sample and hold circuit transmits sampled force signals 1711 to the ADC. The ADC digitizes the sampled force signals and creates a position signal 1713 that is transmitted to the controller FIG. 9 is an electrical schematic of an embodiment of a sample and hold circuit according to the present invention. The sample and hold circuit 1800 comprises an input switch 1802 operably coupled to a sample holding capacitor 1804 and an output switch 1805. The input and output switches are controlled by sample control signals 1806 received from a controller. The sample control signals include an input enable signal 1808 used to open and close the input switch and an output enable signal 1810 used to open and close the output switch.

In operation, the sample and hold circuit receives an input enable signal and output enable signal from a controller and closes the input and output switches in response. An input signal received at an input terminal 1812 supplies charge to the sample holding capacitor, charging the sample and hold capacitor until the sample and hold capacitor's voltage level equals the voltage level of the input signal. The controller turns off the input enable signal and the input switch opens in response, this traps the input signal as a sampled signal maintained by the charge stored in the sample and hold capacitor. The sampled signal is transmitted from the sample and hold circuit via an output terminal 1814.

In one embodiment of a sample and hold circuit according to the present invention, a second input switch, second sample and hold capacitor, and second output switch 1816 is provided for dual ended input signals.

In one embodiment of a sample and hold circuit according to the present invention, the output switches are not included.

In one embodiment of a sample and hold circuit according to the present invention, an output buffer is placed at the output side of the sample and hold circuit to prevent the charge held by the sample and hold capacitor from being dissipated during a measurement process.

Referring again to FIG. 8, the signal processing circuit further comprises a Digital to Analog Converter (DAC) 1712 operably coupled to the gain amplifier. The controller uses the DAC to supply an offset voltage 1714 to the amplifier. The offset voltage is used to adjust the differential input signal levels to the amplifier in order to maximize the useful range of the signal processing circuit. The offset voltage compensates for the tolerance of the resistive sensor network in the pointing device sensor.

The amplifier and DAC amplify the force signals for the ADC and cancel the offset caused by resistor tolerances. The amplifier is differential to reduce noise. The amplifier accepts VHigh, VMid, VLow and the DAC output (V_{OFFSET}) as inputs. The output of the amplifier is differential (V_{H} and V_{L}), centered on a bias voltage in the center of the ADC range (V_{BIAS}). The gain of the amplifier is given by A.

The following equations describe the operation of the amplifier in conjunction with the DAC:

V_{L}=V_{BIAS}−A/2((VHigh−VMid)−(VMid−VLow)−V_{OFFSET})=V_{BIAS}−A/2(I(R_{H}−R_{L})−V_{OFFSET})

V_{L}=V_{BIAS}+A/2((VHigh−VMid)−(VMid−VLow)−V_{OFFSET})=V_{BIAS}+A/2(I(R_{H}−R_{L})−V_{OFFSET})

For measurement of the X axis, R_{H}=X1 and R_{L}=X2. For measurement of the Y axis, R_{H}=Y1 and R_{L}=Y2. For measurement of the Z axis, R_{H}=R_{z} and R_{L}=R_{BRIDGE}.

In one embodiment of a signal processing circuit according to the present invention, the output of the amplifier is singular and not differential.

In operation, the controller transmits axis measurement control signals 1715 to the multiplexer. The multiplexer energizes the resistive sensor network for each axis, X, Y, and Z, according to the selected axis as previously described. The controller transmits gain control signals 1716 to the amplifier according to which axis is being measured. The controller transmits offset control signals 1718 to the DAC according to which axis is being measured. The DAC transmits an offset signal to the amplifier in response to the received offset control signals. The controller transmits sample and hold control instructions 1720 to the sample and hold circuit in order to capture the amplified force signals. The sample and hold circuit holds the amplified force signals for further processing by the ADC. The controller then de-energizes the resistive sensor network.

The sample and hold circuit holds the amplified force signals for the ADC. The controller transmits ADC control signals 1722 to the ADC instructing the ADC to initiate a digitizing cycle. The ADC digitizes the sampled force signals and creates a digital position signal 1713 and transmits the digital position signal to the controller. The controller repeats the process for each axis as needed, energizing the resistive sensor network each time a sample is needed and de-energizing the resistive sensor network while the ADC digitizes the sampled signals.

Operation of a signal processing circuit in the previously described manner reduces the power consumption of the resistive network because the resistive network is only partially energized for short periods of time while the sample and hold circuit's capacitors are being charged. The sample and hold circuit is isolated from the amplifier and the resistive network is de-energized during the time the ADC is converting the sampled amplified force signals held by the sample and hold circuit. This leads to a reduced current consumption.

The current requirement of a resistive network operated in the foregoing manner is given by:

$${I}_{R MS} = I \sqrt{\frac{{T}_{a}}{T}}$$

Where:

I_{RMS}=effective current draw for the resistive network;

I=maximum current draw for the resistive network;

Tₐ=total measurement period; and

T=time between measurements.

In one embodiment of a signal processing system according to the present invention, the signal processing circuit does not include a sample and hold circuit. In this embodiment, the power consumption of the resistive network is reduced because the resistive network is only partially energized during most of a measurement cycle.

The preceding description has been presented with reference to specific embodiments of the invention shown in the drawings. Workers skilled in the art and technology to which this invention pertains will appreciate that alteration and changes in the described processes and structures can be practiced without departing from the spirit, principles and scope of this invention.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the claims supported by this application and their equivalents rather than the foregoing description.

What is claimed is:

1. In a cursor control system, a cursor control input device comprising:
a columnar element operatively extending from a flexible substrate;
a first pair of operatively coupled resistive elements mounted to the substrate, the resistivity of the first pair of resistive elements changing with flexing of the substrate, the first pair of resistive elements being operatively coupled to a current source;
a first signal indicative of the resistivity of a first resistive element of the first pair of resistive elements;
a second signal indicative of the resistivity of a second resistive element of the first pair of resistive elements; and
a signal processing circuit receiving the first signal and the second signal, the signal processing circuit providing an output indicative of the magnitude of a force applied to the columnar element.

2. The cursor control input device of claim 1 wherein the first pair of resistive elements are mounted to the substrate substantially on opposite sides of a location on the substrate from which the columnar element operatively extends.

3. The cursor control input device of claim 2 further comprising a second pair of resistive elements mounted to the substrate, the second pair of resistive elements comprising a third resistive element and a fourth resistive element, the resistivity of the second pair of resistive elements changing with flexing of the substrate, the second pair of resistive elements being mounted to the substrate substantially on opposite sides of a location on the substrate from which the columnar element operatively extends, with a line formed by locations of the first pair of resistive elements and a line formed by locations of the second pair of resistive elements being substantially perpendicular.

4. The cursor control input device of claim 1, the signal processing circuit including:
an amplifier receiving the first signal and the second signal, the amplifier generating a first intermediate signal;
an analog to digital converter receiving the first intermediate signal, the analog to digital converter generating the output indicative of the magnitude of a force applied to the columnar element.

5. The cursor control input device of claim 4, the signal processing circuit further including a digital to analog converter, the digital to analog converter generating an offset signal received by the amplifier.

6. The cursor control input device of claim 5, the signal processing circuit further including a controller including control logic, the controller transmitting control signals to the amplifier, the analog to digital converter, and the digital to analog converter.

7. The cursor control input device of claim 1, the signal processing circuit including:
an amplifier receiving the first signal and the second signal, the amplifier generating a first intermediate signal;
a sample and hold circuit receiving the first intermediate signal, the sample and hold circuit generating a second intermediate signal;
an analog to digital converter receiving the second intermediate signal, the analog to digital converter generating the output indicative of the magnitude of a force applied to the columnar element.

8. The cursor control input device of claim 7, the signal processing circuit further including a digital to analog converter, the digital to analog converter generating an offset signal received by the amplifier.

9. The cursor control input device of claim 8, the signal processing circuit further including a controller including control logic, the controller transmitting control signals to the amplifier, the analog to digital converter, and the digital to analog converter.

10. In a cursor control system, a cursor control input device comprising:
a columnar element operatively extending from a flexible substrate;
a first pair of operatively coupled resistive elements mounted to the substrate, the resistivity of the first pair of resistive elements changing with flexing of the substrate;
a second pair of operatively coupled resistive elements mounted to the substrate, the resistivity of the second pair of resistive elements changing with flexing of the substrate;
a current source;
means for selectively coupling the first and second pair of resistive elements to the current source creating a resistive network;
a first signal indicative of the resistivity of a first resistive element of the resistive network;
a second signal indicative of the resistivity of a second resistive element of the resistive network; and
a signal processing circuit receiving the first signal and the second signal, the signal processing circuit providing an output indicative of the magnitude of a force applied to the columnar element.

11. The cursor control input device of claim 10 wherein the selected pair of resistive elements are mounted to the substrate substantially on opposite sides of a location on the substrate from which the columnar element operatively extends.

12. The cursor control input device of claim 11 wherein a line formed by locations of the first pair of resistive elements and a line formed by locations of the second pair of resistive elements are substantially perpendicular.

13. The cursor control input device of claim 10 further comprising:
a reference resistive element; and
means for coupling the reference resistive element to the first and second resistive element pairs and the current source to create the resistive network.

14. The cursor control input device of claim 13, the signal processing circuit including:
an amplifier receiving the first signal and the second signal, the amplifier generating a first intermediate signal;
an analog to digital converter receiving the first intermediate signal, the analog to digital converter generating the output indicative of the magnitude of a force applied to the columnar element.

15. The cursor control input device of claim 14, the signal processing circuit further including a digital to analog converter, the digital to analog converter generating an offset signal received by the amplifier.

16. The cursor control input device of claim 13, the signal processing circuit including:
an amplifier receiving the first signal and the second signal, the amplifier generating a first intermediate signal;
a sample and hold circuit receiving the first intermediate signal, the sample and hold circuit generating a second intermediate signal;
an analog to digital converter receiving the second intermediate signal, the analog to digital converter generating the output indicative of the magnitude of a force applied to the columnar element.

17. The cursor control input device of claim 16, the signal processing circuit further including a digital to analog converter, the digital to analog converter generating an offset signal received by the amplifier.

18. A signal processing system for reducing a sensor's power consumption, the signal processing system comprising:
a controller including signal processing logic;
a switch coupling the sensor to a power source, the switch receiving a first signal from the controller;
an amplifier receiving a second signal from the sensor;
a sample and hold circuit receiving a third signal from the amplifier and receiving a fourth signal from the controller; and
an analog to digital converter receiving a fifth signal from the sample and hold circuit.

19. The signal processing system of claim 18, the signal processing system further comprising a digital to analog converter receiving a sixth signal from the controller and transmitting a seventh signal to the amplifier.

20. The signal processing system of claim 19, wherein the amplifier is a programmable gain amplifier receiving an eighth signal from the controller.

21. A signal processing system for a sensor, the sensor including a set of resistive elements, the signal processing system comprising:
means for selectively energizing a subset of the set of resistive elements to create an energized resistive network;
means for processing a first signal received from the energized resistive network; and
means for controlling the means for selectively energizing a subset of the set of resistive elements to create an energized resistive network and the means for processing a first signal received from the energized resistive network.

22. The signal processing system of claim 21, wherein the means for processing a first signal received from the energized resistive network includes:
means for amplifying the first signal to generate a second signal; and
means for digitizing the second signal.

23. The signal processing system of claim 22, wherein the means for processing a first signal received from the energized resistive network further includes means for applying an offset signal to the means for amplifying the first signal to generate a second signal.

24. The signal processing system of claim 22, wherein the means for processing a first signal received from the energized resistive network further includes means for sampling and holding the second signal while the second signal is being digitized.

25. The signal processing system of claim 23, wherein the means for controlling the means for selectively energizing a subset of the set of resistive elements to create an energized resistive network and the means for processing a first signal received from the energized resistive network includes means for de-energizing the means for selectively energizing a subset of the set of resistive elements to create an energized resistive network while the second signal is being digitized.
